(19) United States
(12) Patent Application Publication
(10) Pub. No.: US 2026/0200200 A1
(43) Pub. Date: Jul. 16, 2026

(54) IMPROVED APPARATUS AND METHOD OF MANUFACTURE FOR FILTER MEDIA ASSEMBLY

(71) Applicants: Brian Morris, Louisville, KY (US); Bill Noel, Fisherville, KY (US)

(72) Inventors: Brian Morris, Louisville, KY (US); Bill Noel, Fisherville, KY (US)

(21) Appl. No.: 19/449,350

(22) Filed: Jan. 14, 2026

Related U.S. Application Data
(60) Provisional application No. 63/745,295, filed on Jan. 14, 2025.

(51) Int. Cl. B31F 1/26; B31D 5/00; B31D 5/04

(52) U.S. Cl. CPC B31F 1/26; B31D 5/0082; B31D 5/04

(57) ABSTRACT

The present invention teaches an improved apparatus and method for pleating air filter assemblies. The improved apparatus is a rotary pleater which includes a belt and pulley system to facilitate movement of pleated filter media and reduce snags and jams. The apparatus is further modular and portions may be separated in order to provide easier access to the inner workings of the device to conduct maintenance or remove jammed or snagged filter media. Finally, the machine and the methodology embodied in the machine, pre-cuts the filter media into sections prior to pleating of the section(s).

### CROSS-REFERENCE TO RELATED APPLICATIONS

This application claims the benefit of the filing date of U.S. Provisional Patent Application Ser. No. 63/745,295 filed on Jan. 14, 2025.

### FIELD OF THE INVENTION

The present invention relates to the manufacture of air filter assemblies for heating, ventilation, and air conditioning applications. More specifically, it relates to the improvement of pleating machines used to pleat filter media for air filter assemblies.

### BACKGROUND OF THE INVENTION

Almost all forced air heating, ventilation, and air conditioning (HVAC) systems in use today incorporate at least some type of air filter in order to reduce or eliminate airborne particles and contaminants. Such air filters often consist of an assembly having a rectangular frame with some type of filter media secured within the frame. Various types of filter media may be used in these applications. Air filters are often pleated filter media consisting of one or more layers of polypropylene, polyethylene, and/or polycotton material(s).

Filters of this nature may be classified according to their Minimum Efficiency Reporting Value (MERV). A MERV rating reports the average particle size efficiency of the filter, within the numerical range of zero to sixteen (and a final maximum rating of high efficiency). One common type of air filter relies upon a needle punching methodology in order to achieve the desired level of fiber bonding. Needle punch filter media can be more easily manufactured with a high MERV rating at a lower cost (than other types of filter media) which makes such filters a frequent choice for modern HVAC filtering applications.

However, the number, size, and/or geometry of the fibers will change as the MERV rating of needle punch media is increased. Needle punch filter media is sometimes informally referred to as “cotton candy” due to the “fuzzy” nature of the filter. As a result, needle punch filter media tends to snag or tangle during the pleating stage of air filter assembly manufacture. This leads to jams and a stoppage of the line in order to clear the jam. Clearing such jams, particularly when occurring with great frequency, leads to a considerable decrease in productivity and higher manufacturing costs.

There exists, therefore, a need for an improved apparatus and an associated methodology, to more efficiently process needle punch filter media and to reduce the need for human intervention during the process.

### BRIEF DESCRIPTION OF THE DRAWINGS

FIG. 1 is a perspective view of the pleating apparatus.

FIG. 2A is a top view of the pleating apparatus.

FIG. 2B is a side view of the pleating apparatus.

FIG. 3A is a perspective view of a pleating apparatus with detached sections showing the area of magnification seen in FIGS. 3C-3D.

FIG. 3B is a side view of the pleating apparatus with detached sections showing the area of magnification seen in FIGS. 3C-3D.

FIG. 3C is cut-away side view of the belt and pulley system in the pleating section of the apparatus.

FIG. 3D is a perspective detailed view of the belt and pulley system in the pleating section of the apparatus.

FIG. 3E provides a cut-away side view of a prior art pleating system.

FIG. 3F provides a perspective view of a prior art pleating system.

FIG. 4A is a perspective view of the apparatus with the sections detached.

FIG. 4B is a detailed view of a portion of the pleating section.

FIG. 4C is a detailed view of a portion of the pull roller assembly.

FIG. 5 is an exploded view of the pleat head section.

FIG. 6 is an exploded view of the pleat head assembly.

FIG. 7A is a cut away, side view of the pleat head assembly.

FIG. 7B is a cut away, side view of the pleat head section noting magnified section in FIG. 7A.

FIG. 8A is a cut-away view of a first side of the pleating apparatus noting magnified section in FIG. 8D.

FIG. 8B is a cut-away view of a second side of the pleating apparatus noting magnified section in FIG. 8D.

FIG. 8C is a cut-way view of internal components of the pleating apparatus.

FIG. 8D is a second cut-way view of internal components of the pleating apparatus.

FIG. 9A is a top view of the pleating apparatus in expanded (open) form.

FIG. 9B is a side view of the pleating apparatus in expanded (open) form.

FIG. 10A is a rear view of the pleating apparatus.

FIG. 10B is a side view of the pleating apparatus.

FIG. 10C is a front view of the pleating apparatus.

### DETAILED DESCRIPTION

The invention consists of an improved rotary pleating machine having novel features. The machine incorporates a belt and pulley system which reduces the frequency of jams of filter media being processed by the machine. The machine is also modular in nature to facilitate easy removal of jams and required maintenance. Finally, the machine pre-determines the size of each section of filter media being pleated and a cutting mechanism pre-cuts each section prior to pleating.

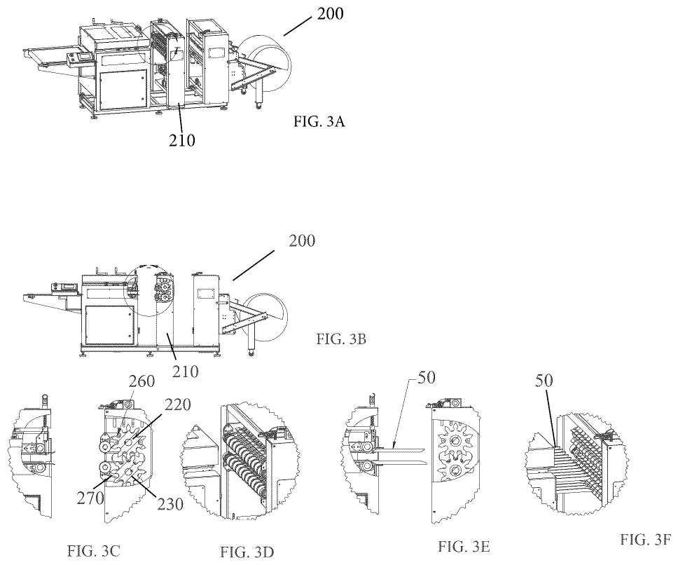

Apparatuses and methods of pleating paper for the production of air filters are well-known in the art. One highly effective means for pleating is through the use of a rotary pleater having cooperating star shaped pleat heads. This type of prior art machine, shown in FIGS. 3E and 3F, conventionally relies upon a plurality of pairs of stationary fingers 50 or bars which receive the pleated media and facilitate the movement of the pleated media to the next section of the pleating apparatus. As reflected in FIG. 3E, the stationary fingers 50 slide in between the pleat head stars. In this prior art arrangement, the movement of the rotary pleat heads themselves provides the motive force for moving the processed media and the pleat head stars are responsible for pushing or moving the pleated media into the bunching section of the machine.

While this may have been a satisfactory design for many years, it is not as effective when processing MERV rated needle punch filter media (“MERV Media”) and/or filter media of lower quality. As discussed supra, MERV Media frequently snags and jams during the pleating process. The stationary fingers are one of the primary reasons that such media jams during the pleating process in a prior art pleater of this nature.

The present invention eliminates the prior art fingers and replaces them with a rotating carrier system. In the preferred embodiment, this carrier system comprises a rotating belt system. The rotating belt system pulls the pleated media away from the star pleat heads and into the next section (the bunching conveyor) of the machine. The use of the belt action to move the filter media substantially reduces snags and jams when processing needle punch media and/or lower quality media in general.

The invention discloses a pleating apparatus 200 having a pull roller assembly 205, pleating section 210 utilizing rotary pleat head(s), and a bunching section 215. The pleating section 210 incorporates upper 220 and lower 230 rotary cooperating pleat heads as found in the prior art. The pleat heads 220, 230 are mounted, respectively, upon upper and lower pleat head shafts 240, 250 which rotate the respective pleat heads 220, 230 during the pleating process. A rotating belt carrier system, however, is also incorporated therein. V-groove pulleys are keyed to the upper and lower pleat head shafts. Belts are mounted upon the v-groove pulleys. The belts are rotated in conjunction with the rotation of the rotary pleat heads.

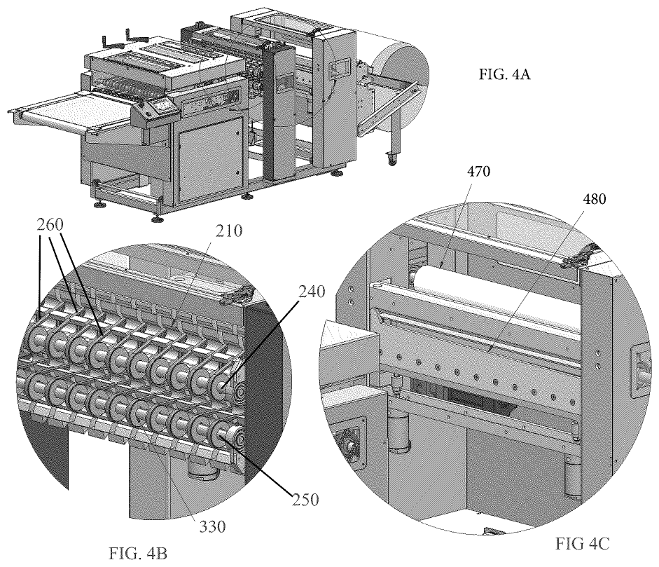

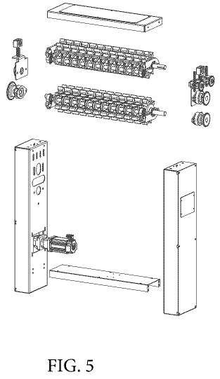

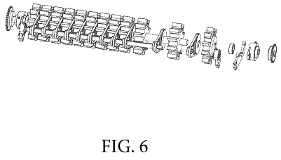

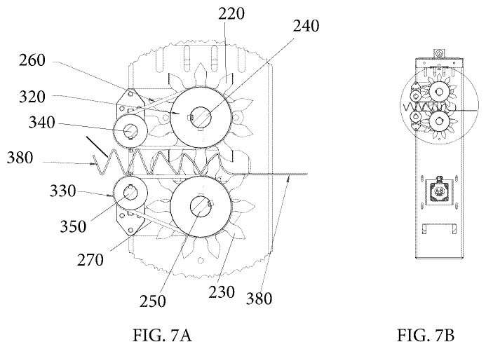

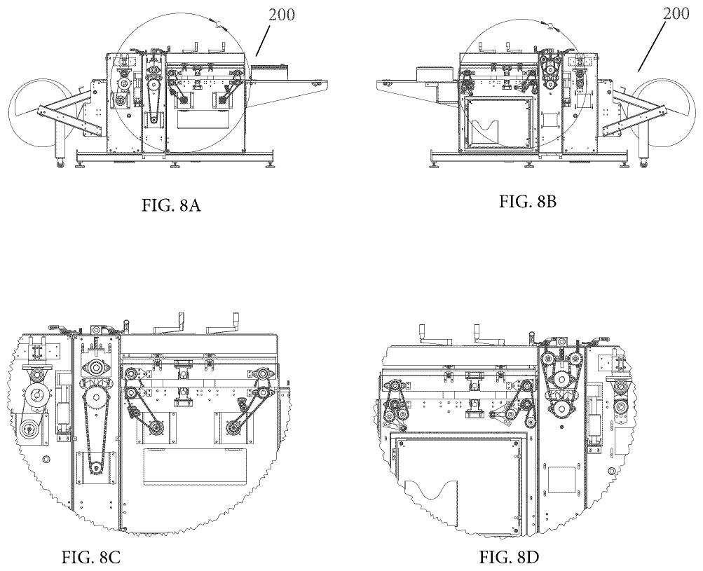

More specifically, the rotating belt system consists of a plurality of aligned upper 260 and lower 270 belts, and associated pulleys 280, 290, as illustrated in FIGS. 4B and 7A, which are positioned between, i.e., on either side of, each pleat head 220, 230. Each set of belts 260, 270 comprises an upper belt arrangement 300 and a lower belt arrangement 310 which are essentially parallel to one another. Each belt arrangement specifically consists of a large v-groove pulley 320, a small v-groove pulley 330, and a belt. The large v-groove pulleys 320 are keyed to, and mounted upon, respective pleat head shafts 240, 250. The small v-groove pulleys 330 of the upper belt arrangement are mounted on an upper mounting shaft 340 and the small v-groove pulleys of the lower belt arrangement are mounted on a lower mounting shaft 350.

In operation, a servo pre-cut pleater unwind 360 supplies the media for the pleating process. The media is drawn from the unwind 360, through the pull roller assembly 370 to the rotary pleater head section.

The belts 260, 270 extend in a direction away from each respective pleat head toward the bunching conveyor. The movement of the pleat heads rotates the belts via the pleat head shaft. The belts maintain contact with the media 380 as the media 380 passes through the pleat head and travels along the pleating process. As seen in FIG. 7C, the upper belt maintains contact with the upper pleat points of the media and the lower belt maintains contact with the bottom pleat points of the media. The movement of the belt system transports the media 380 away from the pleat heads, thereby preventing or substantially reducing jams in the pleating section of the machine. The pleated material progresses, in part by means of the rotating belt system disclosed herein, further through the machine for any additional processing until it ultimately exits at the exit conveyor assembly 390.

The foregoing is in contrast to the prior art arrangement, shown in FIGS. 3E-F, in which solid stationary fingers 55 slide in-between the pleat head stars. In such arrangement, the prior art device relies upon the pleat head stars to move or push the pleated media into the bunching section of the machine.

Polyurethane v-belts, or any v-belt possessing similar characteristics, are used for the belt system. In a preferred embodiment, shore 80A polyurethane v-belts with a nominal width of 10 mm and thickness of 6.5 mm are used. This particular belt choice provides for quicker repair or replacement because the belt can be butt-splice welded on-site in a short amount of time. The polyurethane material also offers some “tack” to help grip the media and pull it away from the pleat head during operation of the machine. The rotating belt system is the preferred embodiment since it provides a smooth, continuous surface. However, alternate embodiments of the system may use a chain or similar carrier in place of the belts. Nonetheless, it will be noted that the use of a chain may increases the likelihood of a snag or jam of the filter media.

The machine may also include guide fingers 400 which extend from the third section of the machine towards the second section of the machine. The guide fingers 400 are stainless steel projections which help guide the pleat pack from one section of the device to the next during processing. These guide fingers 400 are of limited length and do not extend between the pleat head stars. Approximately four guide fingers would be included in the preferred embodiment.

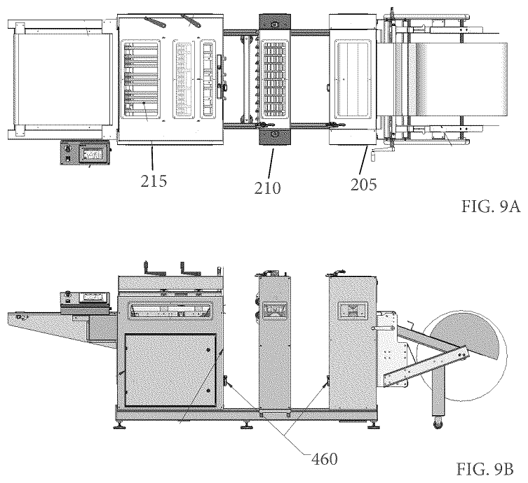

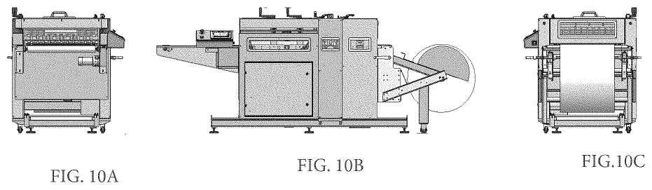

In addition to the foregoing, the machine possesses other beneficial features to reduce jamming and increase overall productivity. Turning to FIG. 9A and B, the pleater assembly is modular in nature, consisting of three sections or portions which are mounted on a roller frame 410. The first section 420 incorporates the unwinder and the pull-roller assembly. The second section 210 is the pleating section which includes the rotary pleating head. The third and final section 430 consists of the bunching assemblies and the exit conveyor. The pleater assembly is operated in closed form. However, two or more of the sections may be separated when the machine is not in use in order to assist with maintenance and to more easily, and quickly, locate and clear jams and snags in the pleating section and other sections.

In the preferred embodiment, the first and third sections may be moved, away from the second section, along tracks in the roller frame 410. In such an embodiment, the second section maintains a fixed position on the roller frame 410. It will be recognized, however, that alternate designs may allow for travel of the second section and/or fixation of the first or third section(s). As show in FIGS. 9A and 9B, the roller mechanism relies upon v-groove track rollers 450 in conjunction with anti-tip brackets 460. The brackets 460 maintain contact between the track rollers 450 and the roller frame 410.

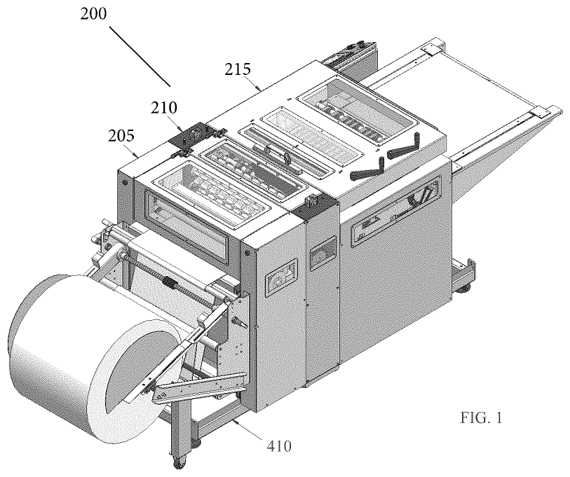

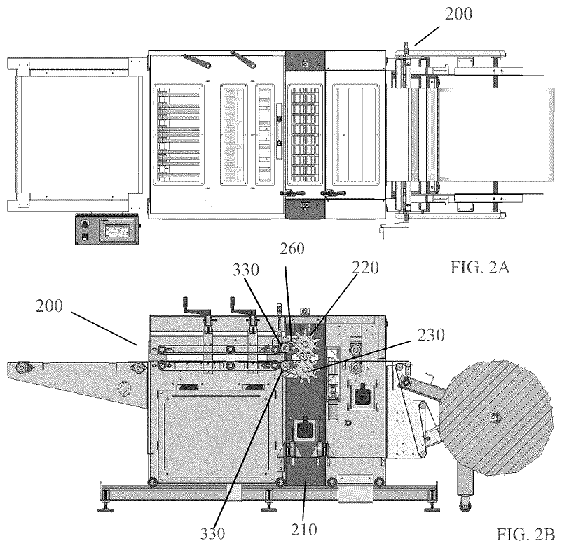

The fully assembled or closed machine, ready for operation, is shown, for example, in FIG. 1. Referring to FIG. 9B, electromagnetic safety latches 460 are used to secure the assembly and prevent unwanted separation of the modules when the machine is in operation. It will be recognized that easier access to assembly components and faster clearance of jams in the pleating section will directly contribute to increased productivity when processing and pleating needle punch media.

Finally, the instant invention differs from conventional pleating machines and methodologies in that pre-cut media is feed into the pleating section. In the prior art process, planar sheets of filter media are continuously fed into the pleating section. The finished product, i.e., the pleated media, is cut while exiting the pleating machine, after pleating is complete.

Using the machine and methodology disclosed herein, pre-cut sheets of filter media are fed to the pleating section. The necessary length of each section is determined based upon the desired size of the final filer media, the pleat height, and the total number of pleats. Referring to FIG. 4B, the filter media is unwound and fed (pulled) into the assembly by servo-driven pull-roller 470. The pull-roller 470 feeds a specified length of filer media to a pneumatic knife 480. The pneumatic knife 480 then cuts the media to the pre-determined length. The media section of pre-determined length is then feed into the pleating section, pleated, processed and, ultimately, exits the assembly.

While the invention has been described in reference to certain preferred embodiments, it will be readily apparent to one of ordinary skill in the art that certain modifications or variations may be made to the device without departing from the scope of invention described in the foregoing specification.

1. An improved rotary pleating machine having a belt and pulley system comprising:
an upper and a lower pleat head shaft;
an upper and a lower belt shaft;
an upper belt assembly operating in conjunction with said upper pleat head shaft and said upper belt shaft; and,
a lower belt assembly operating in conjunction with said lower pleat head shaft and said lower belt shaft.

2. The improved rotary pleating machine of claim 1 wherein said upper belt assembly comprises a large v-groove pulley attached to said upper pleat head shaft, a small v-groove pulley attached to said upper belt shaft, and a belt attached to and connecting said pulleys.

3. The improved rotary pleating machine of claim 2 wherein said lower belt assembly comprises a large v-groove pulley attached to said lower pleat head shaft, a small v-groove pulley attached to said lower belt shaft, and a belt attached to and connecting said pulleys.

4. The improved rotary pleating machine of claim 3 wherein the belt on said upper belt assembly is positioned directly above the belt on said lower belt assembly.

5. The improved rotary pleating machine of claim 4 further comprising a plurality of upper and lower belt assemblies.

6. A modular rotary pleating machine for pleating filter media comprising
a roller frame having a track therein;
a first unwinder, puller and cut section positioned on said roller frame and a having a projection seated in said track;
a second pleat head section positioned on said roller frame and having a projection seated in said track; and,
a third bunching and finishing section positioned on said roller frame and having a projection seating said track;
wherein said sections may be either in contact or moved apart on said roller frame.

7. An improved rotary pleating machine having a means to cut filter media, being unwound into the machine, to a pre-determined length.

8. The improved rotary pleating machine of claim 7 wherein said cutting means comprises, in part, a pneumatic knife.

9. A method of pleating air filter media, said method comprising the steps of:
unwinding a roll of filter media and pulling said media into a rotary pleating machine;
measuring and cutting a portion of said filter media based upon pre-determined criteria to produce a section of media;
pleating said section of media through the use of a plurality of rotary pleat heads;
moving said section of media from said pleat heads to a bunching section through the use of a belt and pulley system; and,
sizing said pleats and completing the pleating process.
